(19) United States
(12) Patent Application Publication
(10) Pub. No.: US 2008/0257688 A1
(43) Pub. Date: Oct. 23, 2008

(54) Device for Conveying Items

(75) Inventor: Antonio Martelli, Bologna (IT)

Correspondence Address: WILLIAM J. SAPONE;COLEMAN SUDOL SAPONE P.C., 714 COLORADO AVENUE, BRIDGE PORT, CT, 06605, US

(73) Assignee: O.A.M. S.P.A., Rastignano (IT)

(21) Appl. No.: 11/815,466

(22) PCT Filed: Feb. 1, 2006
(86) PCT No.: PCT/IB06/00368

§ 371 Date: Aug. 3, 2007

(30) Foreign Application Priority Data
Feb. 7, 2005 (IT) BO2005 A 000058

(51) Int. Cl. B65G 47/74; B65G 47/06

(52) U.S. Cl. 198/470.1

(57) ABSTRACT

The proposed endless conveyor device (1) for conveying items (2) includes a plurality of compartments (4), which receive items (2), released by an adjacent transferring line (3). Each of the compartments (4) has a bottom (40), with a pair of lateral walls (41, 42) connected to its upper part. At least one of the walls rotates with respect to the other, to increase the inlet section of the compartment (4) in step relation with the receiving of an item (2).

### FIELD OF THE INVENTION

The present invention relates to automatic packaging of items into packages.

Specifically, the present invention relates to a device for conveying items, particularly indicated for feeding a packaging machine.

### DESCRIPTION OF THE PRIOR ART

There are transferring devices, which are capable of releasing items, with or without the help of pushing means, into corresponding compartments made in the feeding conveyor of a packaging machine.

The compartments are usually delimited by a bottom, having lateral walls, which are crosswise with respect to an item feeding direction. The mutual distance between the walls is adjusted according to the items size.

There is also another type of compartments, defined by pairs of transversal prongs, arranged on the two longitudinal sides of the feeding conveyor, mutually spaced in relation to the items size.

The releasing of the items into the compartments of the feeding conveyor is extremely difficult in case of items, which do not have a well defined shaped, square and/or rigid, but which are characterized by an irregular and/or soft structure.

In the last case, a non perfect items orientation can jeopardize the correct release thereof into the corresponding compartments of the feeding conveyor, which can result in jamming of the machine, causing serious effects on the equipment production rate.

Similar problems occur in case of feeding conveyors operated continuously, because it is difficult to release items into the corresponding compartments.

### SUMMARY OF THE INVENTION

The object of the present invention is to propose a device for conveying items, particularly indicated for feeding packaging machines, which allows correct and efficient receiving of the items, that are released intermittently, by a corresponding transferring device, into relative compartments, independently from the structure and/of the items shape, as well as from the mutual orientation of the transferring and conveying devices.

Another object of the present invention is to propose a conveying device, which assures high reliability and production rate in any operation conditions, independently from the device operation way, continuous or stepwise, and/or from the size of items under process.

A further object of the present invention is to propose a conveying device, which is extremely functional and versatile, and which assures particularly rapid and easy installation and maintenance operations.

The above mentioned objects are obtained, in accordance with the contents of the claims, by a device for conveying items, including an endless conveyor and a plurality of compartments made on said endless conveyor for receiving the items released by a release station of a transferring line arranged at an angle with respect to the conveying device, with each of said compartments including a bottom and a pair of lateral walls connected to an upper part of the bottom;

the device being characterized in that at least one wall of said lateral walls of each one of said compartments is rotated with respect to the other wall of said lateral walls, so as to increase an inlet section of said compartment in step relation with receiving of an item, with a mutual inclination of said lateral walls being adjusted by first adjusting means.

### BRIEF DESCRIPTION OF THE DRAWINGS

The characteristic features of the invention will be pointed out in the following description of some preferred but not exclusive embodiments, with reference to the enclosed figures, in which:

FIGS. 1A, 1B, 1C, 1D are schematic, top views of a compartment of the proposed conveying device in particularly relevant, subsequent operation steps;

FIG. 2 is a schematic, enlarged, top view of the line in some extremely indicative operation steps.

### BEST MODES OF CARRYING OUT THE INVENTION

Having regards to the above mentioned Figures, the general reference number 1 indicates the proposed device for conveying items 2, which includes, for example, an endless conveyor operated e.g. continuously, and is particularly designed for feeding a packaging machine.

The device features a plurality of compartments 4 for receiving items 2, released intermittently by a release station S of a transferring line 3.

Each compartment has a bottom 40, with a pair of lateral walls 41, 42 connected thereto.

The transferring line 3, arranges at an angle with respect to the conveying device 1, includes a working area which is coplanar with the upper run of the conveying device 1, and in which the items 2 are released into the relevant compartments 4.

The Figures show a transferring line 3, which for example, is orthogonal to the conveying device 1.

Each compartment 4 of the conveying device 1 includes a moving lateral wall 42, which can rotate with respect to the other motionless lateral wall 41, to allow the inlet section of compartment 4 to increase while receiving an item 2; and first means for adjusting the mutual inclination of the lateral walls 41, 42.

The first adjusting means include a linking mechanism 5, connected to the lateral, rotating wall 42, and cooperating with guiding means 6, which are connected to the stationary framework of the conveying device 1.

The linking mechanism 5 makes the rotating wall 42 rotate on an axis, orthogonal to the bottom 40.

The adjusting means include means 7, which interact with the linking mechanism 5 and with the bottom 40 of the compartment 4, and which perform an elastic action on the lateral, rotating wall 42.

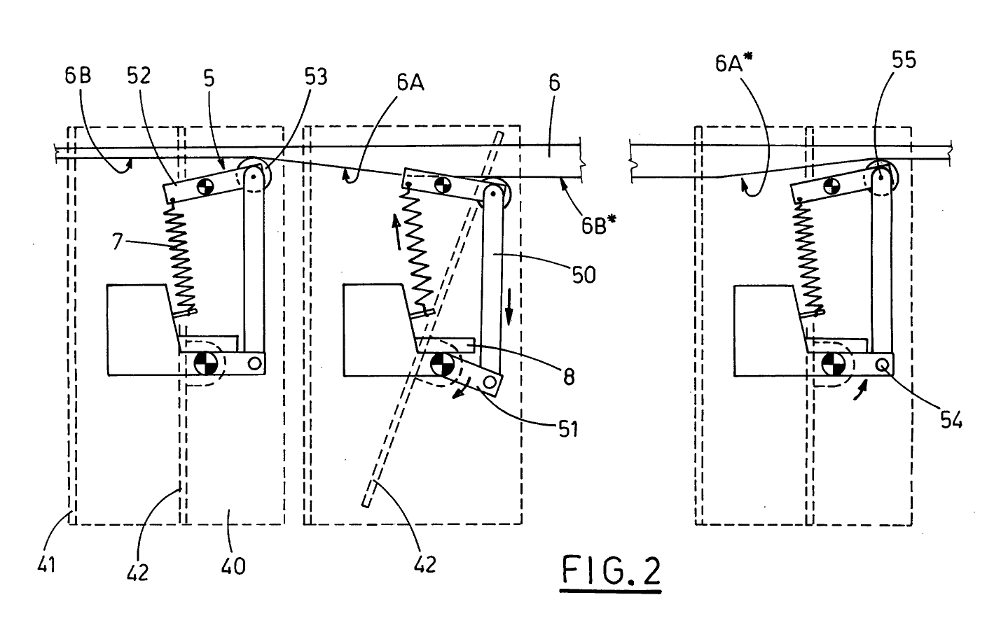

With particular reference to FIG. 2, the linking mechanism 5 includes a first lever 51, hinged to the bottom 40 and carrying the lateral, rotating wall 42, rigidly and removably fastened to one of its ends, and with the other end carrying a pin 54 with a connecting rod 50.

The elastic means 7 act on one end of a second lever 52, which is likewise hinged to the bottom 40, and which has the other end carrying a pin 55 with the same connecting rod 50.

An idle roller 53 engages with the guiding means 6, to allow the lateral, rotating wall 42 to be rotated.

For instance, the roll 53 is carried idle by the pin 55 of the second lever 52 with the connecting rod 50 (FIG. 2), but it can be also connected, according to the specifications, only to the second lever 52, or only to the connecting rod 50, according to other embodiments, not shown.

The linking mechanism 5 includes also abutment means 8, connected to the bottom 40 of the compartment 4 and defining a stable parallel configuration of the pair of lateral walls 41, 42, against the elastic reaction performed by the elastic means 7.

For example, the abutment means 8 include an arm, which defines an end stop for the pin 54 between the first lever 51 and the connecting rod 50.

Advantageously, the dimensions of the first lever 51 and the second lever 52, as well as of the connecting rod 50 are such as to form a linkage allowing the connecting rod 50 to be operated orthogonal to the feeding direction W of the conveying device 1.

For instance, the guiding means 6, cooperating with the linking mechanism 5, include a cam profile, which is aimed at engaging with the roll 53 and shaped according to a plurality of straight, parallel parts 6B, 6B* and inclined parts 6A, 6A*, as considered with respect to the feeding direction W of the conveying device 1.

Advantageously, the inclined parts 6A, 6A* are shaped in such a way, as to rotate the lateral, rotating wall 42, while the parallel parts 6B, 6B* are shaped in such a way, as to stabilize the lateral walls 41, 42 in the configurations of the minimum and/or maximum inlet section of the compartment 4.

The operation principle of the proposed conveying device 1 will be briefly explained, with particular reference to a general working step, in which the idle roll 53 of a compartment 4 engages with a first parallel part 6B of the profile 6, which allows to keep parallel the relative lateral walls 41, 42 in the configuration of minimum inlet section of the compartment 4.

In the minimum inlet section configuration, the pin 54 of the first lever 51 with the connecting rod 50 goes stably in abutment against the abutment arm 8, facilitated by the action of the elastic means 7.

In a transition region of the cam profile 6 from the first parallel part 6B to the first inclined part 6A, the first lever 51 is forced, to rotate clockwise, against the elastic means 7, thus operating the lateral, rotating wall 42 up to its maximum opening stroke at the end of the inclined part 6A.

In the transition region of the cam profile 6 from the first inclined part 6A to the second parallel part 6B*, and along the whole length of the latter, the lateral, rotating wall 42 remains motionless with respect to the lateral wall 41, thus defining the maximum inlet section of the compartment 4.

The transferring of an item 2 into a relative compartment 4 is performed in step relation with the positioning of the compartment in front of the release station S of the transferring line 3, and with the definition of the maximum inlet section of the compartment 4.

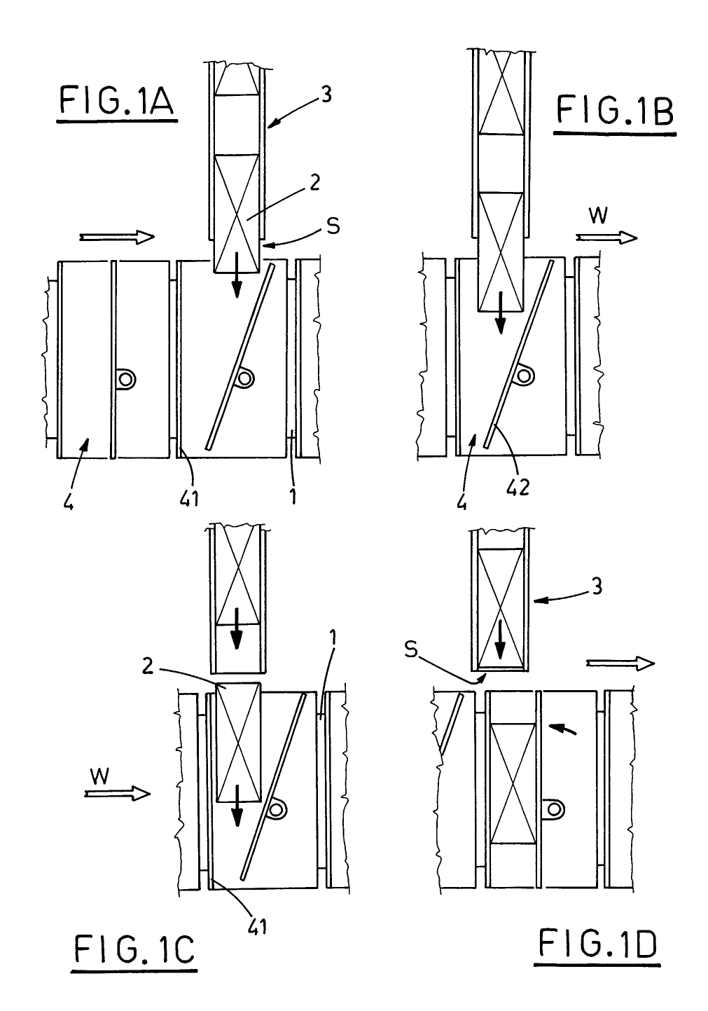

FIGS. 1A, 1B, 1C show succeeding operation steps by which an item 2 is transferred from the transferring line 3 to the compartment 4 of the conveying device 1, facing the line 3, with gradual introduction of the item 2 into the compartment 4.

In the transition region of the cam profile 6 from the second parallel part 6B* to the second inclined part 6A*, the first lever 51 is forced to rotate counterclockwise, facilitated by the return action of the elastic means 7, thus operating the lateral, rotating wall 42 to rotate, up to the configuration, in which it is parallel to the motionless, lateral wall 41 at the end of the second inclined part 6A*.

In this way, the item 2, released between the lateral walls 41, 42 of the compartment 4 is compacted and stabilized (FIG. 1D).

In the transition region of the cam profile 6 from the second inclined part 6A* to a first parallel part 6B, the lateral walls 41, 42 are kept parallel, in the configuration of the minimum inlet section of the compartment 4, with the pin 54 of the first lever 51 with the 50 stably in abutment against the abutment arm 8.

According to another embodiment, not shown, each compartment 4 can have at least one lateral wall 41, 42, translating with respect to the other, and second means for adjusting the distance between the lateral walls 41, 42.

This allows a bigger flexibility and versatility of the conveying device 1, when the size of the items 2 is to be changed even substantially, and/or to increase the inlet section of the compartments 4 during the items 2 receiving.

According to a further embodiment, not shown, both lateral walls 41, 42 of each compartment 4 can rotate one with respect to the other, on axes orthogonal to the bottom 40 of the respective compartment 4.

The operation way of the proposed conveying device 1 is the same, independently from how it is moved forward, either continuously or stepwise.

It is easily understood that the proposed conveying device, indicated for feeding a packaging machine, assures a correct and efficient receiving of the items, released intermittently by a relative transferring line, into the corresponding compartments, independently from the structure and/or the shape of the items, as well as from the mutual orientation of the conveying device and the transferring line.

Actually, the line allows to avoid all the problems of prior art connected to processing items, which do not have a well defined geometry, square and/or rigid, but which are characterized by an irregular and/or soft structure.

In fact, in the last case, the proposed conveying device assures a correct receiving of the items in the relative compartments, even if the orientation of the latter is not good, thus reducing strongly the occurrence of equipment jamming, facilitating its best productivity.

The considerable increase of the inlet section of each compartment during the receiving of items, released intermittently by the transferring line, allows optimal receiving by the proposed conveying device, independently from its operation mode, either stepwise or continuously.

The possibility to adapt the conveying device to the items size in a particularly rapid and easy way assures high productivity standards in any working condition.

1. A device for conveying items, including an endless conveyor and a plurality of compartments (4) made on said endless conveyor for receiving the items (2) released by a release station (S) of a transferring line (3) arranged at an angle with respect to the conveying device, with each of said compartments (4) including a bottom (40) and a pair of lateral walls (41, 42) connected to an upper part of the bottom;
the device being characterized in that at least one wall (42) of said lateral walls (41, 42) of each one of said compartments (4) is rotated with respect to the other wall (41) of said lateral walls (41, 42), so as to increase an inlet section of said compartment (4) in step relation with receiving of an item (2), with a mutual inclination of said lateral walls (41, 42) being adjusted by first adjusting means.

2. A device as claimed in claim 1, characterized in that it includes said transferring line (3) is substantially orthogonal to said conveying device and releases items (2) intermittently into said compartments (4).

3. A device as claimed in claim 1, characterized in that said first adjusting means include a linking mechanism (5), connected to the lateral, rotating wall (42) and cooperating with guiding means (6) connected to a stationary framework of the conveying device (1), said linking mechanism (5) driving the rotating wall (42) into rotation about an axis substantially perpendicular to the bottom (40) of said compartment (4).

4. A device as claimed in claim 3, characterized in that said first adjusting means include means (7), which interact with said linking mechanism (5) and with said compartment (4), and which perform an elastic action on the lateral, rotating wall (42).

5. A device as claimed in claim 4, characterized in that said linking mechanism (5), cooperating with said guiding means (6), includes:
a first lever (51), hinged to said bottom (40) and carrying the lateral, rotating wall (42), rigidly and removably fastened to one of its ends, and with the other end carrying a pin (54) for pivot connection with a connecting rod (50);
a second lever (52), likewise hinged to said bottom (40), and having one end connected to said elastic means (7), and another end carrying a pin (55) for pivot connection with said connecting rod (50);
abutment means (8), connected to said bottom (40) and defining a stable, parallel configuration of said pair of lateral walls (41, 42).

6. A device as claimed in claim 5, characterized in that said linking mechanism (5) includes an idle roller (53) for engagement with the guiding means (6), to drive the lateral, rotating wall (42).

7. A device as claimed in claim 6, characterized in that said roll (53) is carried idle by the pin (55) for connecting the second lever (52) with said connecting rod (50).

8. A device as claimed in claim 5, characterized in that said connecting rod (50) is operated in a direction substantially orthogonal to the feeding direction (W) of the conveying device (1).

9. A device as claimed in claim 5, characterized in that said abutment means (8) include an arm, which defines an end stop for said pin (54) for connecting the first lever (51) and the connecting rod (50).

10. A device as claimed in claim 5, characterized in that said guiding means (6) include at least one cam profile, which engages with said roll (53) and shaped according to a plurality of parallel parts (6B, 6B*) and inclined parts (6A, 6A*) with respect to the feeding direction (W) of the conveying device (1); with said inclined parts (6A, 6A*) operating the lateral, rotating wall (42) into rotation, and with said parallel parts (6B, 6B*) stabilizing the lateral walls (41, 42) in the minimum and/or maximum inlet section configuration of said compartment (4).

11. A device as claimed in claim 1, characterized in that at least one of said lateral walls (41, 42) translates with respect to the other, to increase the inlet section of the compartment (4) during the item (2) receiving and/or during adaptation to the size of the item; and in that it includes second means for adjusting the mutual distance between the pair of lateral walls (41, 42).

12. A device as claimed in claim 1, characterized in that both lateral walls (41, 42) rotate one with respect to the other.

13. A device for conveying items, as claimed in claim 1, in particular operated continuously.

14. A device for conveying items, as claimed in claim 1, in particular for feeding a packaging machine.
